(19) United States
(12) Patent Application Publication
(10) Pub. No.: US 2013/0146271 A1
(43) Pub. Date: Jun. 13, 2013

(54) HEATING/COOLING DEVICE AND METHOD FOR OPERATING A HEATING/COOLING DEVICE

(71) Applicants: Tilo Schäfer, Daubach (DE); Stefan Schüssler, Frankfurt (DE); Uwe Becker, Butzbach (DE)

(72) Inventors: Tilo Schäfer, Daubach (DE); Stefan Schüssler, Frankfurt (DE); Uwe Becker, Butzbach (DE)

(21) Appl. No.: 13/818,584

(22) PCT Filed: Aug. 16, 2011
(86) PCT No.: PCT/DE2011/001619

§ 371 Date: Feb. 22, 2013

(30) Foreign Application Priority Data
Aug. 24, 2010 (DE) 10 2010 035 272.1

(51) Int. Cl. B60H 1/32; B60H 1/14

(52) U.S. Cl. CPC B60H 1/323; B60H 1/14; B60H 1/3213
USPC 165/202; 62/333; 62/506; 62/513; 62/79; 62/115

(57) ABSTRACT

The proposal is for a heating/cooling device for vehicles, in particular motor vehicles with electric drive, having a refrigerant circuit, which comprises a compressor (3), a gas cooler (5), an evaporator (7) and an expansion valve arranged between the gas cooler (5) and the evaporator (7). The heating/cooling device is characterized in that the gas cooler (5) interacts with a first liquid coolant circuit (9), and the evaporator (7) interacts with a second liquid coolant circuit (11), wherein an interior heat exchanger (17) can be assigned to the first or the second liquid coolant circuit (9, 11), and wherein an external-air heat exchanger (19) can be assigned to the first or the second liquid coolant circuit (9, 11).

The invention relates to a heating/cooling device in accordance with the preamble of Claim 1 and to a method for operating a heating/cooling device in accordance with the preamble of Claim 7.

Heating/cooling devices and methods for operating same are known. Particularly in vehicles, heating/cooling devices are used to bring the internal temperature of a passenger cell to a pleasant level, preferably to adjust it to a predetermined temperature. Typically, a separate heating and a separate cooling device are provided, which are activated or deactivated separately from one another according to requirements. The cooling device comprises a refrigerant circuit, which comprises a compressor, a gas cooler, an evaporator and an expansion valve arranged between the gas cooler and the evaporator. Particularly in the gas cooler and in the compressor, heat is liberated, and this heat is released as waste heat in the known devices without being used to heat the passenger cell. In the case of known devices, it is found overall that the various heat sources and heat sinks which are available on a vehicle are not interconnected or at least are not interconnected in an optimum manner, and there are therefore no synergistic effects. In some cases, additional heat sources, e.g. an electric heating device, are provided. Particularly in the case of vehicles with electric drive, this leads to an increased energy requirement and hence simultaneously to a shorter range.

It is therefore an object of the invention to provide a heating/cooling device for vehicles in which the possible heat sources and heat sinks of the vehicle, in particular of an electric vehicle, are interconnected in such a way that they can be used in an optimum manner, thereby making it possible to achieve considerable synergistic effects and energy savings.

This object is achieved by providing a heating/cooling device having the features of Claim 1. This is characterized in that the gas cooler interacts with a first liquid coolant circuit, and the evaporator interacts with a second liquid coolant circuit, wherein an interior heat exchanger can be assigned to the first or the second liquid coolant circuit, and wherein an external-air heat exchanger can be assigned to the first or the second liquid coolant circuit. By virtue of the fact that the two heat exchangers can each be assigned to the first or the second liquid coolant circuit, the various heat sources and heat sinks of the vehicle can be interconnected and hence can be used in an optimum manner.

Preference is given to a heating/cooling device in which, in a heating mode, the first liquid coolant circuit interacts with the interior heat exchanger, and the second liquid coolant circuit interacts with the external-air heat exchanger. As a result, the external-air heat exchanger can be used as a heat source for the heating mode. That is to say, heat is taken from it. In this case, spray, high air humidity, rain or snow may lead to the formation of a layer of ice on the surface thereof. This has an insulating effect, with the result that the capacity of the external-air heat exchanger as a heat source decreases. In a deicing mode, therefore, the first liquid cooling circuit preferably interacts both with the interior heat exchanger and with the external-air heat exchanger. In this case, the external-air heat exchanger is connected up as a heat sink and can be deiced. In a cooling mode, the first liquid coolant circuit preferably interacts with the external-air heat exchanger, and the second liquid coolant circuit interacts with the interior heat exchanger. The evaporator can then be used as a heat sink for cooling the interior.

As a particularly preferred option, the first liquid coolant circuit interacts with a valve device, by means of which the liquid coolant can be fed to the interior heat exchanger, the external-air heat exchanger or to both, depending on the operating mode. The second liquid coolant circuit preferably interacts with a valve device, by means of which the liquid coolant can be fed to the external-air heat exchanger, the interior heat exchanger or to neither of the heat exchangers, depending on the operating mode.

In heating mode and in cooling mode, the compressor is preferably assigned to the liquid coolant circuit which interacts with the external-air heat exchanger. This makes it possible to dissipate the operational heat thereof, particularly in cooling mode. In heating mode, the waste heat of the compressor is preferably included in the heat output fed to the interior heat exchanger.

Preference is also given to a heating/cooling device in which the first or the second liquid coolant circuit interacts with a third liquid coolant circuit. Said circuit is used to control the temperature of an electric storage element. This can be an accumulator and/or a battery, in particular for supplying an electric drive of the vehicle with electric power. Since the electric storage element responds very sensitively to temperature changes, it is expedient to control the temperature thereof or to hold the temperature thereof as constantly as possible in an optimum range.

Finally, preference is given to a heating/cooling device in which an electric motor of the vehicle can be assigned to the first or to the second liquid coolant circuit, with the result that it acts, in particular, as a heat source or possibly as a heat sink. Thus, the electric motor is preferably included as a heat-releasing or possibly also as a heat-absorbing element in the temperature economy of the heating/cooling device.

It is also an object of the invention to provide a method for operating a heating/cooling device according to one of Claims 1 to 6, by means of which heat sources and heat sinks present in the vehicle can be interconnected in such a way that they can be used in an optimum manner.

This object is achieved by providing the method having the features of Claim 7. It is characterized in that, in a heating mode, the external-air heat exchanger is assigned as a heat source to the second liquid coolant circuit. In this case, it can ice up—as already described. In a deicing mode, the external-air heat exchanger is therefore assigned as a heat sink to the first liquid coolant circuit. This enables the external-air heat exchanger to be deiced. In a cooling mode, the external-air heat exchanger is assigned as a heat sink to the first liquid coolant circuit. In this way, it is possible, in particular, to dissipate the heat liberated in the gas cooler.

Preference is given to a method in which, in deicing mode, the electric motor is assigned as a heat source to the second liquid coolant circuit. The waste heat of the electric motor can then be utilized, and it is included in the heat output fed to the interior heat exchanger.

The heating/cooling device is preferably switched to deicing mode if icing of the external-air heat exchanger is identified.

This is preferably detected from the fact that a reduction in the capacity of the latter as a heat source is identified.

Particular preference is given to a method in which icing of the external-air heat exchanger is identified as follows: the external-air heat exchanger interacts as a heat source with the second liquid coolant circuit. A first temperature gradient with respect to time is recorded. An alternative heat source, preferably the electric motor, interacts with the second liquid coolant circuit. A second temperature gradient with respect to time is recorded. The temperature gradients recorded are compared, and icing of the external-air heat exchanger is identified if the first temperature gradient is steeper than the second temperature gradient. The steeper profile of the first gradient indicates that, when the external-air heat exchanger is connected as a heat source, the measured temperature falls more rapidly because supplementary heat from the environment cannot be supplied quickly enough owing to the insulating layer of ice. The system therefore switches to deicing mode if the corresponding steeper gradient is detected. For recording the temperature gradients, use is preferably made of detecting elements, which are used in any case for regulating the heating/cooling device. These can be assigned to the liquid coolant circuit or to the refrigerant circuit. As a particularly preferred option, use is made of detecting elements which are provided relatively close to, preferably directly on, the two heat sources under investigation. This makes it possible to determine the behavior thereof in a particularly accurate way. Especially if the detecting elements are mounted directly on the heat sources, it is possible to record both gradients—preferably simultaneously or in parallel, i.e. with a time overlap for example—where both heat sources are assigned to the second liquid coolant circuit. However, at least the external-air heat exchanger is preferably removed from the second liquid coolant circuit when the temperature gradient of the alternative heat source is being recorded. The gradients are then preferably measured in succession. As a very particularly preferred option, only the heat source for which the temperature gradient is being measured is assigned to the second liquid coolant circuit. Thus, it is possible to measure the first and the second temperature gradient in succession or simultaneously or in parallel, e.g. with a time overlap.

Finally, preference is given to a method in which icing of the external-air heat exchanger is identified by at least one sensor, preferably an optical sensor. The optical sensor is preferably arranged in such a way that it can directly detect a layer of ice on the external-air heat exchanger.

The sensor can be provided as an alternative or in addition to an evaluation of the temperature gradients.

The invention is explained in greater detail below with reference to the drawing, in which:

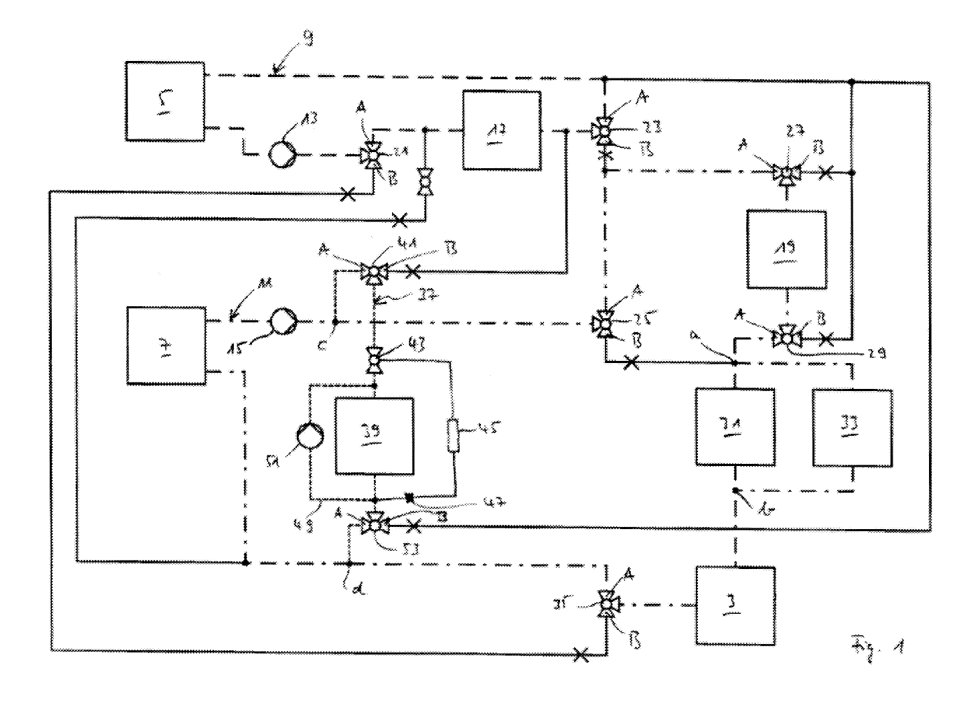

FIG. 1 shows a schematic view of the liquid coolant circuits of one illustrative embodiment of a heating/cooling device in a first operating state;

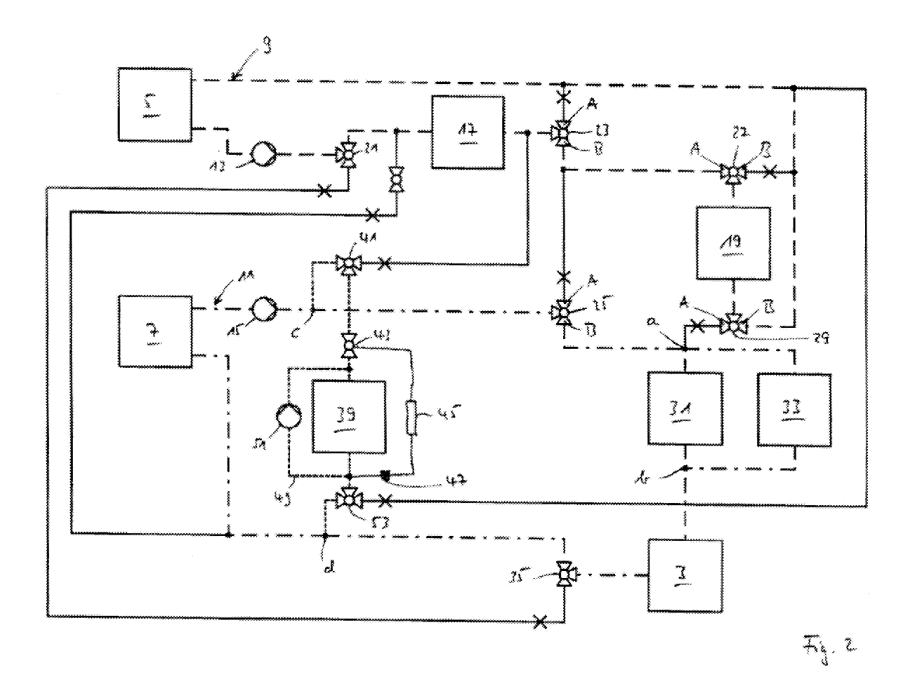

FIG. 2 shows the illustrative embodiment according to FIG. 1 in a second operating state;

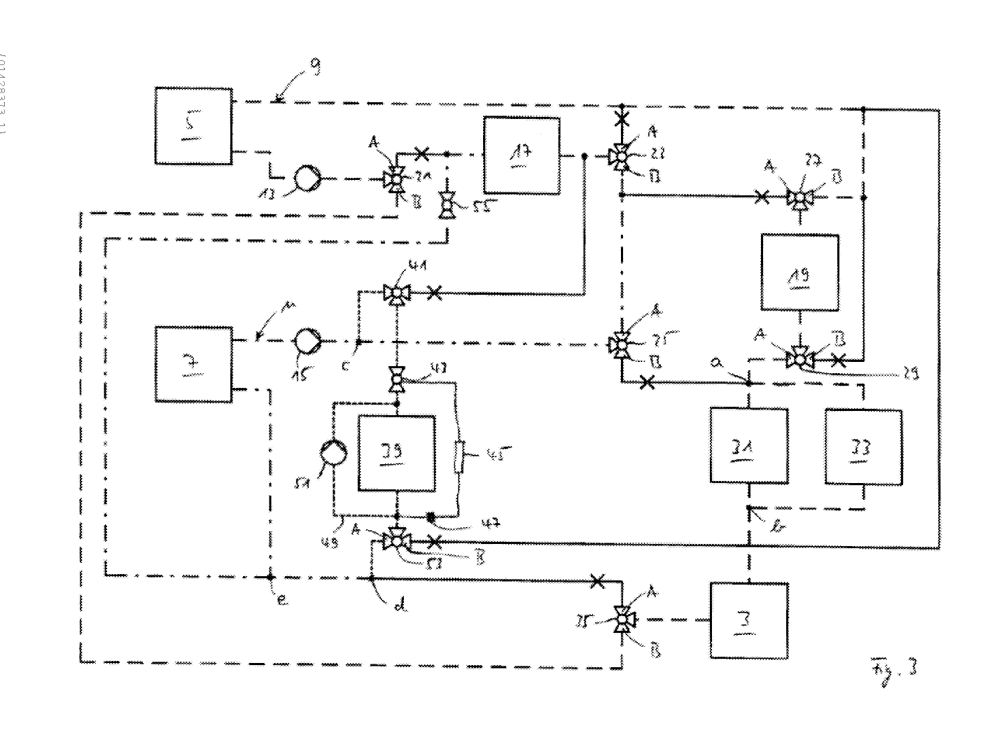

FIG. 3 shows the illustrative embodiment according to FIG. 1 in a third operating state;

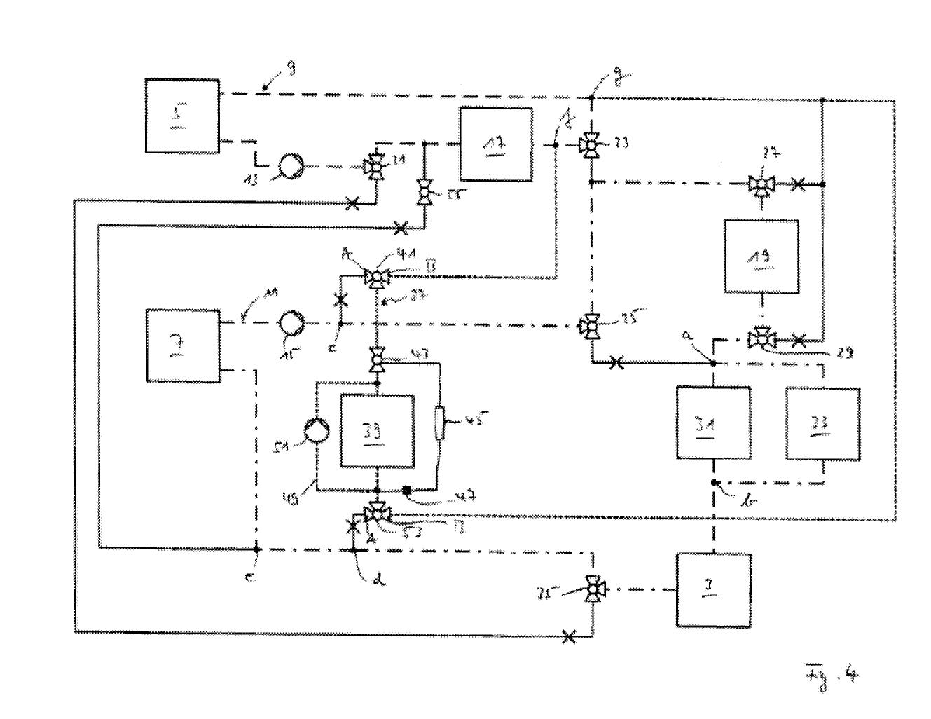

FIG. 4 shows the illustrative embodiment according to FIG. 1 in a fourth operating state;

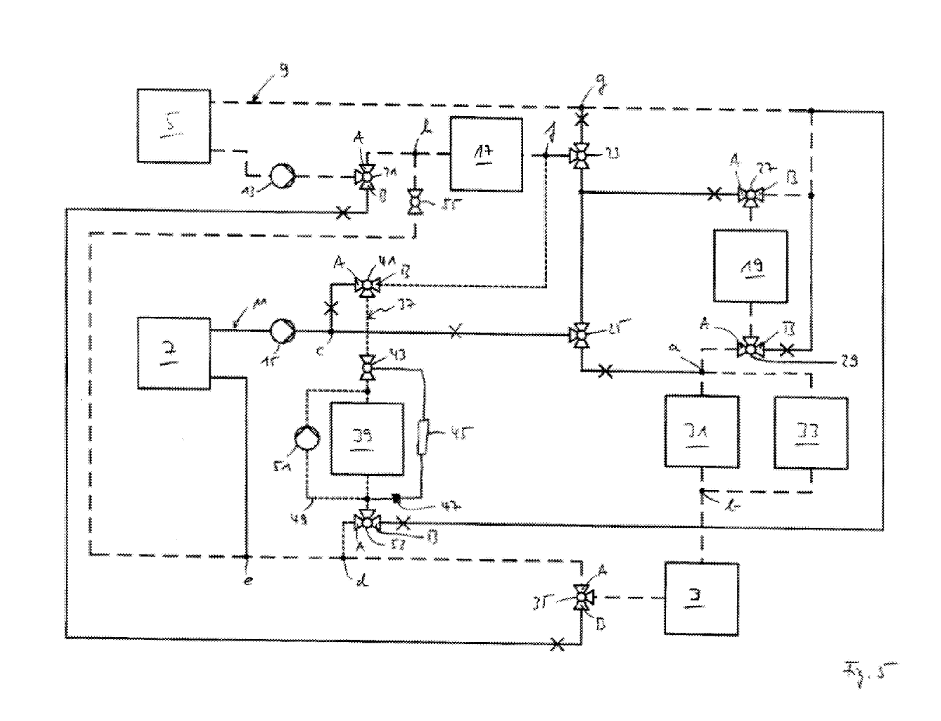

FIG. 5 shows the illustrative embodiment according to FIG. 1 in a fifth operating state.

The essential aspects of the heating/cooling device will be described below; however, the method will be readily apparent from the description of the operating states and functioning thereof.

FIG. 1 shows a schematic view of the liquid coolant circuits of one illustrative embodiment of a heating/cooling device in an operating state in which the interior of a motor vehicle is heated, and an electric storage element is preferably cooled. The refrigerant circuit of the cooling device included in the heating/cooling device is not shown. This circuit comprises a compressor 3, a gas cooler 5 and an evaporator 7, there being an expansion valve arranged between the gas cooler and the evaporator. Carbon dioxide or some other conventional refrigerant is preferably used as the refrigerant.

As a liquid coolant, the liquid coolant circuits shown in FIG. 1 preferably contain water and glycol, in particular a water/glycol mixture. Other liquid coolants are also possible.

The gas cooler 5 interacts with a first liquid coolant circuit 9 (indicated in large dashes here), and the evaporator 7 interacts with a second liquid coolant circuit (indicated by chain-dotted lines here). Pumps 13, 15, which pump the liquid coolant along the liquid coolant circuits 9, 11, are provided. Inactive liquid coolant paths are shown in solid lines and indicated by a cross.

The heating/cooling device comprises an interior heat exchanger 17, through which there is preferably a flow of air and which can be assigned to the first or the second liquid coolant circuit 9, 11. It furthermore comprises an external-air heat exchanger 19, through which there is preferably a flow of air and which can likewise be assigned to the first or the second liquid coolant circuit 9, 11.

A valve device is provided which interacts with the first liquid coolant circuit 9 in such a way that the liquid coolant can be fed to the interior heat exchanger 17, the external-air heat exchanger 19 or to both, depending on the operating mode. In a corresponding manner, a valve device is provided which interacts with the second liquid coolant circuit 11 in such a way that the liquid coolant can be fed to the external-air heat exchanger 19, the interior heat exchanger 17 or to neither of the heat exchangers, depending on the operating mode. These functions can be performed by the same valve device but it is also possible to provide two separate valve devices. The valve device or the valve devices preferably comprises or comprise at least one valve, particularly preferably a plurality of valves. In the illustrative embodiment shown, various on-off and changeover valves are provided, forming overall a valve device which provides the functionality described. In other preferred illustrative embodiments, the number, type and arrangement of the valves can be varied. The essential point is that the functionality explained in connection with the present illustrative embodiment is ensured.

A knowledge of the refrigerant circuit (not shown in the figures) is important for an understanding of the invention. The refrigerant is compressed in the compressor 3 and heats up greatly in the process. It passes to the gas cooler 5, where it releases a large proportion of the heat absorbed in the compressor 3 to the liquid coolant circuit.

An intermediate heat exchanger is preferably arranged downstream of the gas cooler—as seen in the direction of flow—where the refrigerant releases heat to refrigerant flowing back to the compressor 3. From there, the compressed and pre-cooled refrigerant passes to an expansion valve, where it is expanded. During this process, it cools to a great extent. It flows onward to the evaporator 7, where it absorbs heat from the liquid coolant. From there, it preferably flows via the intermediate heat exchanger, where it absorbs additional heat from the refrigerant coming from the gas cooler 5, back to the compressor 3. An expansion vessel or tank for the refrigerant is preferably provided downstream of the evaporator—as seen in the direction of flow.

The heating mode of the heating/cooling device for heating a passenger cell will be explained in greater detail below with reference to FIG. 1:

In the gas cooler 5, the fluid flowing to pump 13 has absorbed heat from the hot compressed refrigerant. The hottest point of the heating/cooling device is therefore more or less downstream of the gas cooler 5 and upstream of pump 13—as seen in the direction of flow. Said pump pumps the liquid coolant to a changeover valve 21, which—as with all the changeover valves mentioned below—has one undesignated port and two ports of which one is designated A and the other is designated B. In heating mode, the connection between the undesignated port and the port designated A is open, while port B is closed.

In the changeover valves, it is preferably possible to implement two operating states, with one of the designated ports being connected to the undesignated port in each of the operating states, while the third port is closed.

The liquid coolant passes from changeover valve 21 to the interior heat exchanger 17, wherein it releases at least some of its heat to the passenger cell, preferably to an air stream flowing to the passenger cell. It flows onward to a changeover valve 23, the undesignated port of which is connected to port A. The port designated B is closed. The liquid coolant therefore flows from valve 23 back to the gas cooler 5, where it once again absorbs heat from the compressed hot refrigerant.

The liquid coolant in the second liquid coolant circuit 11 flows from the evaporator 7, via pump 15, to a changeover valve 25. In the evaporator 7 it has released heat to the expanded cold refrigerant. The coldest point in the heating/cooling device is therefore situated more or less downstream of the evaporator 7 and upstream of pump 15—as seen in the direction of flow.

In the operating state shown, the undesignated port is connected to port A, while port B is closed. The liquid coolant therefore flows onward to a changeover valve 27, port A of which is connected to the undesignated port, while port B is closed.

From there, the liquid coolant flows through the external-air heat exchanger 19 to a changeover valve 29. Since the liquid coolant is colder here than an external temperature, it absorbs heat from the environment in the external-air heat exchanger 19. Said heat exchanger therefore acts as a heat source. In the operating state shown, the undesignated port of changeover valve 29 is connected to port A. The liquid coolant flows onward to a junction a, where it is preferably split between a liquid cooling jacket of an electric motor 31 and/or of a control device 33, which is used to control the electric motor 31. In another preferred illustrative embodiment, the liquid coolant can flow only to the electric motor 31 or only to the control device 33. The control device 33 is preferably designed as a pulse-controlled inverter. The liquid coolant preferably absorbs waste heat from the electric motor 31 and/or the control device 33, and these elements therefore act as heat sources in the operating state shown.

In another preferred illustrative embodiment, it is possible for the electric motor 31 and the control device 33 to be arranged not in parallel—as shown in FIG. 1—but in series, i.e. one behind the other, as regards the flow of liquid coolant. In this case, the control device 33 is preferably provided upstream of the electric motor 31; the liquid coolant thus preferably flows initially through the liquid cooling jacket of the control device 33 and then through that of the electric motor 31.

At a junction b, the preferably split flows of liquid coolant are recombined. From there, said coolant flows to a liquid cooling jacket of the compressor 3, which likewise acts as a heat source, and therefore the liquid coolant absorbs the waste heat thereof. It then passes to a changeover valve 35, port A of which is connected to the undesignated port, while port B is closed. From there, the coolant flows back to the evaporator 7.

The following is thus observed: the cold liquid coolant coming from the evaporator 7 absorbs ambient heat in the external-air heat exchanger 19 in heating mode. The coolant is fed back to the evaporator 7, where it releases heat to the refrigerant of the refrigerant circuit (not shown). This refrigerant accordingly passes to the compressor 3 after being preheated. It has therefore absorbed heat which has been taken from the environment by the external-air heat exchanger 19. The refrigerant is heated further in the compressor 3 and is fed to the gas cooler 5, where it releases at least some of its heat to the liquid coolant in the first liquid coolant circuit 9.

Ultimately, therefore, the heat taken from the environment by the external-air heat exchanger 19 is additionally available to the interior heat exchanger 17 for heating the interior. The heating/cooling device thus provides a heat pump which transfers heat from the comparatively cool external-air heat exchanger 19 to the comparatively warm interior heat exchanger 17, with mechanical work being supplied in the compressor 3.

Since heat is taken from the external-air heat exchanger 19, a layer of ice may form on the surface thereof due to air humidity, rain water, spray, snow or other sources of moisture, especially in the cold months of the year. This acts increasingly as an insulating layer, with the result that the external-air heat exchanger 19 can no longer operate efficiently as a heat source. A deicing mode is therefore preferably provided in order to remove the layer of ice from the external-air heat exchanger 19. This will be explained in conjunction with FIG. 2.

In FIG. 1, a third liquid coolant circuit 37 is shown in small dashes, said circuit interacting with either the first or the second liquid coolant circuit 9, 11 in order to control the temperature of an electric storage element 39. In the operating mode shown, the electric storage element 39 is being cooled.

A changeover valve 41 is provided, port A of which is connected to the undesignated port, while port B is closed. Cold liquid coolant is therefore diverted from the liquid coolant circuit 11 at a junction c and fed to the third liquid coolant circuit 37. From there, it passes to an adjustable valve 43, which is controlled by a controller 45. The latter is, in turn, connected to a temperature sensor 47, which detects the temperature in an inner liquid coolant circuit, which flows around the electric storage medium 39. This is formed by a bypass 49, in which a pump 51 is provided that pumps the liquid coolant emerging from the electric storage element 39 back to a coolant inlet, preferably that of a liquid cooling jacket of the electric storage element 39. A changeover valve 53 is provided downstream of the electric storage element 39 and also downstream of a branch of the bypass 49, the undesignated port of said valve being connected to port A, while port B is closed in the operating state shown. From there, the liquid coolant passes to a junction d, where it is fed back into the second liquid coolant circuit 11 and flows back to the evaporator 7. The controller 45 controls the adjustable valve 43 in such a way that the quantity of liquid coolant fed to the liquid coolant circulated via the bypass 49 by pump 51 is suitable for holding the temperature in the inner circuit substantially at a predetermined value. Pump 51 is preferably continuously in operation and keeps the inner circuit running. Since the liquid coolant is substantially incompressible, the quantity of coolant emerging from changeover valve 53 preferably corresponds to the quantity fed in via valve 43.

In a preferred illustrative embodiment, the controller 45 also controls changeover valve 53, and therefore the quantity of liquid coolant flowing out of the inner circuit can be regulated. In this case, it is possible to hold the temperature in the inner circuit constant in a particularly effective manner.

In another preferred illustrative embodiment, changeover valve 53 is switched in accordance with the operating mode of the heating/cooling device and is not regulated.

As already described, the external-air heat exchanger 19 ices up under certain conditions when it is included as a heat source in the heating mode of the heating/cooling device. In this case, the heating/cooling device preferably switches to a deicing mode.

FIG. 2 shows a schematic view of the liquid coolant circuits of the illustrative embodiment of the heating/cooling device according to FIG. 1 in deicing mode. Elements that are the same and have the same function are provided with the same reference signs and therefore attention is drawn in this respect to the preceding description. For the sake of simplicity, only the features which differ from the operating state according to FIG. 1 will be discussed below.

In changeover valve 23, port A is closed, while the undesignated port is connected to port B. The warm liquid coolant flowing in from the gas cooler 5 via the interior heat exchanger 17 in the first liquid coolant circuit 9 is therefore not directed back to the gas cooler 5 by changeover valve 23 but to changeover valve 27. From there, it flows through the external-air heat exchanger 19 to changeover valve 29. Port A of the latter is closed and port B is connected to the undesignated port. The liquid coolant can thus flow back from changeover valve 29 to the gas cooler 5.

In changeover valve 25, port A is closed and port B is connected to the undesignated port. No cold liquid coolant from the second liquid coolant circuit 11 can therefore pass from the evaporator 7 to the external-air heat exchanger 19. Instead, the liquid coolant flows directly from changeover valve 25 to junction a.

The following is thus observed: in deicing mode, the external-air heat exchanger 19 is assigned to the first liquid coolant circuit 9 as a heat sink. It is deiced by the warm liquid coolant.

An alternative heat source must accordingly be assigned or have been assigned to the second liquid coolant circuit 11. In this case, this is preferably the electric motor 31. In the illustrative embodiment shown, the control device 33 is preferably also included as a heat source in the second liquid coolant circuit 11. The compressor 3 also forms a heat source.

As regards the operating conditions of the vehicle, the following is observed: when the vehicle is stationary or traveling only slowly, there is a comparatively low risk of icing on the external-air heat exchanger 19 because at least only a small amount of spray can reach the surface thereof. In this case, there is thus no problem in including the external-air heat exchanger 19 as a heat source in the second liquid coolant circuit 11 in heating mode. If, on the other hand, the vehicle is traveling quickly, there is an increased risk of icing, and therefore it may be necessary to switch to deicing mode. At the same time, a higher output is demanded of the electric motor 31 and large losses in the form of waste heat accordingly arise there. There is therefore no problem in including said electric motor as a heat source in the second liquid coolant circuit 11.

Even if it is necessary to switch to deicing mode in an operating state in which no relevant waste heat arises in the electric motor 31, this is not detrimental: in this case, the electric motor 31 is cooled while heat is removed from it. During this process, its temperature falls only slightly because it has a very large heat capacity. In particular, it preferably comprises a liquid cooling jacket with a large volume. The electric motor 31 does not have to have a high temperature in order to be able to work efficiently. Its efficiency is high even at low temperature. Overall, therefore, there are no reservations about including the electric motor 31 as a heat source in the second coolant circuit 11 in any operating state.

As is clear from FIGS. 1 and 2, the electric motor 31 in the preferred illustrative embodiment shown is assigned as a heat source to the second liquid coolant circuit 11 both in heating mode and in deicing mode. In deicing mode, only the external-air heat exchanger 19 is removed as an additional heat source from the liquid coolant circuit 11 and assigned as a heat sink to the first liquid coolant circuit 9. This procedure is included as a matter of course in the statement that the electric motor 31 and/or an alternative heat source is assigned to the second liquid coolant circuit 11. There is therefore no compelling reason to associate the alternative heat source with the second liquid coolant circuit 11 again; instead, the wording includes an illustrative embodiment in which the alternative heat source remains associated with the circuit.

It is possible to provide a sensor which can directly identify icing of the external-air heat exchanger 19. An optical sensor is preferably used. However, as an alternative or in addition, icing of the external-air heat exchanger 19 is preferably identified from a reduction in its capacity as a heat source.

For this purpose, the following steps are preferred: the external-air heat exchanger 19 interacts as a heat source with the second liquid coolant circuit 11. In this case, a first temperature gradient with respect to time is recorded. In a preferred embodiment, the external-air heat exchanger 19 is removed from the second liquid coolant circuit 11 after a, preferably predetermined, measuring time, and a second temperature gradient with respect to time is recorded, wherein an alternative heat source, preferably the electric motor 31, interacts with the second liquid coolant circuit 11. For this purpose, the alternative heat source is either assigned to the second liquid coolant circuit 11 or remains assigned to it. Once again, preferably after a predetermined measuring time, the temperature gradients recorded in this way are compared with one another. As a particularly preferred option, only the heat source for which a temperature gradient is to be recorded interacts with the second liquid coolant circuit 11. In this case, the heat sources are preferably assigned to the circuit before the corresponding temperature gradient is measured and, if appropriate, are removed from the circuit after measurement. The temperature gradients are then successively measured. In other embodiments, it is possible that at least the alternative heat source, e.g. the electric motor 31, interacts with the liquid coolant circuit 11 during the recording of both temperature gradients.

Detecting elements are preferably used to record the temperature gradients, and these are included in the heating/cooling device in any case. They can include a temperature detecting element in the region of the passenger cell, for example. It is also possible to arrange temperature detecting elements directly on the external-air heat exchanger 19 and on the alternative heat source, preferably the electric motor 31. In this case, in particular, it is possible in one embodiment of the method to determine the temperature gradients of both heat sources simultaneously or with a time overlap while both heat sources are interacting with the second liquid coolant circuit 11.

In one embodiment of the method, it is possible to switch to the deicing mode while the second temperature gradient is still being recorded. The external-air heat exchanger 19 is thus assigned to the first liquid coolant circuit 9 while the temperature gradient for the alternative heat source is still being recorded. After comparison of the temperature gradients, the deicing mode can either be continued or aborted.

Owing to its high heat capacity, the electric motor 31 typically exhibits a less steep temperature gradient, i.e. the temperature thereof falls only slowly over time during use as a heat source. The profile of the temperature gradient of the external-air heat exchanger 19 depends on the degree of icing thereof. The thicker the insulating layer of ice formed, the less heat can be supplied from the outside to the external-air heat exchanger 19 per unit time. Accordingly, the temperature thereof falls more rapidly during its use as a heat source, the more icing has progressed. It is therefore possible to identify icing of the external-air heat exchanger 19 when the temperature gradient thereof is steeper than the temperature gradient of the alternative heat source or electric motor 31. In this case, the system switches to deicing mode.

The same method can be employed in order to confirm adequate deicing of the external-air heat exchanger 19, except that here the system can switch back from deicing mode to heating mode if the temperature gradient of the external-air heat exchanger 19 is less steep than the temperature gradient of the alternative heat source or electric motor 31.

It is possible to check at regular intervals, using the method described, whether the external-air heat exchanger 19 is iced up. In the same way, it is possible to check at regular intervals in the deicing mode whether deicing is already complete.

Overall, it is found that both the interior heat exchanger 17 and the external-air heat exchanger 19 are assigned as heat sinks to the first liquid coolant circuit 9 in deicing mode. It is thus possible simultaneously to heat the passenger cell and to deice the external-air heat exchanger 19. Since an alternative heat source, preferably the electric motor 31, is available to the second liquid coolant circuit 11 in deicing mode, there is no reduction in the power available for heating the passenger cell. Thus, deicing can take place without any noticeable negative effect for the occupants of the vehicle.

FIG. 3 shows a schematic view of the liquid coolant circuits of the illustrative embodiment of the heating/cooling device in cooling mode. Elements which are the same and have the same function are provided with the same reference signs and therefore attention is drawn in this respect to the preceding description. In this case too, only the differences in comparison with the operating mode shown in FIG. 1 are described.

In the case of changeover valve 21, the undesignated port is connected to port B in cooling mode, while port A is closed. The liquid coolant is thus pumped by pump 13 from the gas cooler 5 to changeover valve 35, port B of which is connected to the undesignated port. Port A is closed. The hot liquid coolant of the first liquid coolant circuit 9 coming from the gas cooler 5 accordingly enters the liquid cooling jacket of the compressor 3 and, from the latter, flows onward via junction b to the liquid cooling jacket of the electric motor 31 and preferably also to that of the control device 33. At junction a, the flows are preferably recombined, and the liquid coolant flows via valve 29, port B of which is closed, while port A is connected to the undesignated port, to the external-air heat exchanger 19. From there, it passes to changeover valve 27, port B of which is connected to the undesignated port, while port A is closed. It therefore flows back to the gas cooler 5.

Here, the external-air heat exchanger 19 is incorporated as a heat sink into the first liquid coolant circuit 9. The hot liquid coolant coming from the gas cooler 5 also absorbs the waste heat of the compressor 3. Depending on the operating state of the electric motor 31 and/or of the control device 33, these act as heat sources or as heat sinks. At any rate, the liquid coolant releases the absorbed heat at least partially to the environment in the external-air heat exchanger 19 before flowing back to the gas cooler 5.

It is found that the compressor 3 is assigned to the liquid coolant circuit 9, 11 which interacts with the external-air heat exchanger 19, both in heating mode and in cooling mode. Ultimately, therefore, the operational heat of the compressor 3 can be dissipated via the external-air heat exchanger 19 in each operating state to the extent that it is not included in the heat output for the passenger cell.

In respect of the second liquid coolant circuit 11, the following is observed in cooling mode:

The liquid coolant coming from the evaporator 7 is pumped by pump 15 to changeover valve 25, port A of which is connected to the undesignated port. From there, it flows to changeover valve 23 because port A of changeover valve 27 is closed. In the case of changeover valve 23, port B is connected to the undesignated port, and therefore liquid coolant flows via the interior heat exchanger 17. Here, the cold liquid coolant absorbs heat from the interior, i.e. the passenger cell, and cools the latter in this way.

Because port A of changeover valve 21 is closed, the liquid coolant passes to an on-off valve 55, which is closed in heating and deicing mode but is open in cooling mode. From there, the liquid coolant flows back to the evaporator 7 via a junction e. At junction e, the coolant flows coming from on-off valve 55, on the one hand, and from junction d, on the other hand, when the electric storage element 39 is being cooled, combine. As will be apparent later, no coolant passes from junction d to junction e when the electric storage element 39 is being heated. In this case, namely, port A of changeover valve 53 is closed.

It is found that the interior heat exchanger 17 is assigned to the second liquid coolant circuit 11 in cooling mode, and therefore the passenger cell can be cooled by the cold liquid coolant coming from the evaporator 7.

FIG. 4 shows a schematic view of the liquid coolant circuits of one illustrative embodiment of a heating/cooling device in heating mode, wherein the electric storage element is simultaneously heated. Elements which are the same and have the same function are provided with the same reference signs and therefore attention is drawn in this respect to the preceding description. In respect of FIG. 4 too, only the differences in comparison with the operating mode shown in FIG. 1 are explained.

The heating mode shown in FIG. 4 corresponds substantially to the operating state shown in FIG. 1. The interior heat exchanger 17 is assigned as a heat sink to the first liquid coolant circuit 9. The external-air heat exchanger 19 is assigned as a heat source to the second liquid coolant circuit 11. The first and second liquid coolant circuits 9, 11 operate as described in conjunction with FIG. 1.

In contrast to FIG. 1, however, the electric storage element 39 is not cooled in the operating state according to FIG. 4, but is heated. For this purpose, port B of changeover valve 41 is connected to the undesignated port, while port A is closed. Hot liquid coolant coming from the gas cooler 5, which has already released heat to the passenger cell in the interior heat exchanger 17, flows via a junction f to changeover valve 41 and, from there, to the adjustable valve 43. Said valve is controlled in the manner already described in conjunction with FIG. 1 by the controller 45, which thus feeds a quantity of warm liquid coolant, suitable for holding constant the temperature in the inner circuit and hence also the temperature of the electric storage element 39, to the inner circuit, formed by pump 51 and the bypass 49, around the electric storage element 39. In particular, the temperature of the electric storage element 39 is preferably set to a predetermined value.

In the case of changeover valve 53, port B is connected to the undesignated port in the operating state shown, while port A is closed. The liquid coolant therefore flows via port B to a junction g, where it is combined with the liquid coolant flow from the interior heat exchanger 17 and flows back to the gas cooler 5.

The following is thus observed: in the heating mode of the electric storage element 39, said mode being shown in FIG. 4, the third liquid coolant circuit 37 interacts with the first liquid coolant circuit 9. It is connected in parallel with the latter, as it were as a bypass. Warm liquid coolant is taken from the first liquid coolant circuit 9 at junction f for temperature control of the electric storage element 39 and, ultimately, is fed back in at junction g. The electric storage element 39 acts as a heat sink.

In the cooling mode of the electric storage element 39, said mode being shown in FIG. 1, the third liquid coolant circuit 37 interacts with the second liquid coolant circuit 11. It is connected in parallel with the latter, as it were as a bypass. Cold liquid coolant is taken from the second liquid coolant circuit 11 at junction c and is fed back to said circuit at junction d. The electric storage element 39 acts as a heat source.

In the heating mode of the electric storage element 39, junction f is preferably arranged downstream of the interior heat exchanger 17—as seen in the direction of flow. In this case, the liquid coolant has already released heat to the passenger cell. The electric storage element 39 is thus not exposed directly to the hot liquid coolant coming from the gas cooler 5 but to a lower temperature than this. This is expedient because the electric storage element 39 is temperature-sensitive and, in particular, should not be operated at too high a temperature.

Nevertheless, it is possible in another illustrative embodiment to arrange junction f upstream of the interior heat exchanger 17—as seen in the direction of flow—especially if the supply of liquid coolant to the electric storage element 39 is regulated by the controller 45 by means of the adjustable valve 43. With this regulation too, it is namely perfectly possible to avoid a situation where the electric storage element 39 is supplied with liquid coolant that is too hot.

FIG. 5 shows a schematic view of the liquid coolant circuits of the illustrative embodiment of a heating/cooling device in a passive mode. Elements that are the same and have the same function are provided with the same reference signs and therefore attention is drawn in this respect to the preceding description.

In passive mode, the refrigerant circuit of the heating/cooling device is deactivated, that is to say the compressor 3, in particular, is switched off. At the same time, the refrigerant circuit (not shown) is thereby preferably out of action.

In passive mode, the second liquid coolant circuit 11, in particular pump 15, is also deactivated. This then preferably presents a sufficiently large flow resistance, in particular to any liquid coolant that may be flowing counter to the direction of delivery thereof. In corresponding fashion, the flow in the second liquid coolant circuit 11 stops.

The first liquid coolant circuit 9 and, in particular, pump 13 are active. Liquid coolant therefore flows from the gas cooler 5, via pump 13, to changeover valve 21. Since the compressor 3 is deactivated, however, the liquid coolant does not absorb any heat in the gas cooler 5. In this respect, said cooler thus preferably acts as a passive element and therefore forms neither a heat source nor a heat sink for the first liquid coolant circuit 9.

In the case of changeover valve 21, port A is connected to the undesignated port, while port B is closed. The liquid coolant therefore flows onward to a junction h, which is formed in the operating state under consideration because the on-off valve 55 is open. Via said valve, the liquid coolant flows to changeover valve 35, port A of which is connected to the undesignated port, while port B is closed. The liquid coolant flows onward to the liquid cooling jacket of the deactivated and, to this extent, passive compressor 3, from which it preferably passes via junction b to the liquid cooling jacket of the electric motor 31 and/or to that of the control device 33. The split coolant flows preferably recombine downstream of said elements at junction a. From there, the coolant flows to changeover valve 29, port A of which is connected to the undesignated port, while port B is closed.

From there, the liquid coolant flows through the external-air heat exchanger 19 to changeover valve 27, the undesignated port of which is connected to port B, while port A is closed. From there, it flows back to the gas cooler 5.

In passive mode, the external-air heat exchanger 19 is therefore assigned to the first liquid coolant circuit 9. Waste heat from the electric motor 31 and/or the control device 33 is released to the environment via the external-air heat exchanger.

The passive mode can preferably be used in autumn and in spring, when the outside temperature is, on the one hand, not so hot that the external-air heat exchanger 19 would act as a heat source or that it would be necessary to switch to the cooling mode of the heating/cooling device but, on the other hand, is not so cold that it would be necessary to switch to the heating mode of the heating/cooling device.

The interior heat exchanger 17 is also assigned to the first liquid coolant circuit 9. However, it is arranged downstream of junction h—as seen in the direction of flow. From there, liquid coolant flows to changeover valve 41. This is fed into the third liquid coolant circuit 37 because port B of changeover valve 41 is connected to the undesignated port, while port A is closed. Here, therefore, the third liquid coolant circuit 37 interacts with the first liquid coolant circuit 9. In other respects, the functioning of the third liquid coolant circuit 37 and the temperature control of the electric storage element 39 are identical with the functioning already described. In the case of changeover valve 53, the undesignated port is connected to port A, and therefore the liquid coolant is fed back to the first liquid coolant circuit 9 via junction d and, from there, passes to changeover valve 35.

By means of the interior heat exchanger 17 and the external-air heat exchanger 19, heat exchange between the passenger cell and the surroundings of the vehicle is achieved. In this way, the trend is for the passenger cell to be cooled, particularly when passive mode is activated in autumn or spring.

The electric storage element 39 is also preferably cooled. The waste heat thereof is released via the external-air heat exchanger 19.

Overall, it is found that the heating/cooling device and the method for operating the heating/cooling device allows efficient interconnection and hence optimum usage of the heat sources and heat sinks present in the vehicle, especially in a vehicle with electric drive. In particular, using waste heat from the compressor 3 to heat the interior and incorporating the external-air heat exchanger 19 as a heat source into the heating mode for the passenger cell allows extremely efficient operation. As a result, the heating/cooling device consumes significantly less energy than if an electric resistance heating system were provided. In this way, a vehicle with electric drive, in particular, achieves a range which is preferably up to 30% greater than with a conventional heating/cooling device. Deicing of the external-air heat exchanger 19 is possible simultaneously with the heating mode. Moreover, it is possible to heat or cool the electric storage element 39.

1. A heating/cooling device for a vehicle, in particular a motor vehicle with electric drive, that includes a refrigerant circuit, which comprises a compressor, a gas cooler, an evaporator and an expansion valve arranged between the gas cooler and the evaporator, wherein
the gas cooler interacts with a first liquid coolant circuit, and the evaporator interacts with a second liquid coolant circuit, wherein
an interior heat exchanger can be assigned to the first or the second liquid coolant circuit, wherein
an external-air heat exchanger can be assigned to the first or the second liquid coolant circuit, wherein
in a heating mode, the first liquid coolant circuit interacts with the interior heat exchanger, and the second liquid coolant circuit interacts with the external-air heat exchanger, wherein
in a cooling mode, the first liquid coolant circuit interacts with the external-air heat exchanger, and the second liquid coolant circuit interacts with the interior heat exchanger,
wherein
in a deicing mode, the first liquid coolant circuit interacts both with the interior heat exchanger and with the external-air heat exchanger.

2. A heating/cooling device according to claim 1, wherein
the first liquid coolant circuit interacts with a valve device, by which the liquid coolant can be fed to the interior heat exchanger, the external-air heat exchanger or to both, depending on the operating mode, and
the second liquid coolant circuit interacts with a valve device, wherein the liquid coolant can be fed to the external-air heat exchanger, the interior heat exchanger or to neither of the heat exchangers, depending on the operating mode.

3. A heating/cooling device according to claim 1, wherein the compressor has a liquid cooling jacket, which, in heating mode and in cooling mode, is assigned to the liquid coolant circuit which interacts with the external-air heat exchanger.

4. A heating/cooling device according to claim 1, wherein the first or the second liquid coolant circuit interacts with a third liquid coolant circuit in order to control the temperature of an electric storage element.

5. A heating/cooling device according to claim 1, wherein an electric motor of the vehicle has a liquid cooling jacket, which can be assigned to the first or to the second liquid coolant circuit.

6. A method for operating a heating/cooling device according to claim 1, wherein
in a heating mode, the external-air heat exchanger is assigned as a heat source to the second liquid coolant circuit, and wherein
in a cooling mode, the external-air heat exchanger is assigned as a heat sink to the first liquid coolant circuit,
wherein
in a deicing mode, the external-air heat exchanger is assigned as a heat sink to the first liquid coolant circuit.

7. The method according to claim 6, wherein, in deicing mode, the liquid cooling jacket of the electric motor is assigned as a heat source to the second liquid coolant circuit.

8. The method according to claim 6, wherein the heating/cooling device is switched to deicing mode if icing of the external-air heat exchanger is identified.

9. The method according to claim 6, wherein icing of the external-air heat exchanger is detected from the fact that a reduction in the capacity of the latter as a heat source is identified.

10. The method according to claim 9, wherein icing of the external-air heat exchanger is identified by a method having the following steps:
the external-air heat exchanger interacts as a heat source with the second liquid coolant circuit;
a first temperature gradient with respect to time is recorded;
an alternative heat source, the liquid cooling jacket of the electric motor, interacts with the second liquid coolant circuit;
a second temperature gradient with respect to time is recorded;
the temperature gradients recorded are compared, and
icing of the external-air heat exchanger is identified if the first temperature gradient is steeper than the second temperature gradient.

11. The method according to claim 10, wherein the first temperature gradient and the second temperature gradient are recorded in succession or simultaneously or in parallel with respect to time.

12. The method according to claim 6, wherein icing of the external-air heat exchanger is identified by at least one sensor.

13. The method according to claim 12, wherein said sensor is an optical sensor.
